(19) United States
(12) Patent Application Publication
(10) Pub. No.: US 2026/0348228 A1
(43) Pub. Date: Nov. 5, 2026

(54) SPLASH GUARD

(71) Applicant: STORM ARMOUR, INC., Miami Beach, FL (US)

(72) Inventors: Mark Fisher, Bal Harbour, FL (US); Todd Michael Glaser, Palm Beach, FL (US); Ronald Simkins, Miami, FL (US); David Kreps, Miami Beach, FL (US); Werner Blumenthal, Miami, FL (US)

(73) Assignee: STORM ARMOUR, INC., Miami Beach, FL (US)

(21) Appl. No.: 19/664,441

(22) Filed: Apr. 30, 2026

Related U.S. Application Data
(60) Provisional application No. 63/797,792, filed on Apr. 30, 2025.
(60) Provisional application No. 63/797,796, filed on Apr. 30, 2025.

(51) Int. Cl. E06B 7/26

(52) U.S. Cl. CPC E06B 7/26

(57) ABSTRACT

A splash guard apparatus is disclosed for mitigating water intrusion along a sill of a sliding door or window. The apparatus includes a semi-rigid panel having a vertically oriented portion and a bottom portion, with a foldable region enabling the bottom portion to be positioned relative to the vertical portion. A sealing interface disposed along edges of the panel engages sill and frame surfaces to form a water-resistant barrier. Multiple panels may be arranged in overlapping relation to form a continuous barrier across a door opening.

### CROSS-REFERENCE TO RELATED APPLICATIONS

This application claims the benefit of U.S. Provisional Application No. 63/797,792, filed Apr. 30, 2025, and U.S. Provisional Application No. 63/797,796, filed Apr. 30, 2025, the disclosures of which are hereby incorporated by reference in their entirety.

### FIELD

The present invention generally relates to water barrier devices, and more specifically, to devices and systems for creating an interior water barrier for sliding glass doors in residential structures such as high-rise condominiums, townhouses, apartments, and private homes.

### BACKGROUND

Sliding glass doors commonly installed in residential dwellings utilize tracks with weep holes to drain water. Under normal conditions, these weep holes adequately manage water drainage. However, during severe weather conditions involving wind-driven rain, these weep holes become ineffective, allowing water to infiltrate the interior space through gaps between the sliding doors and tracks. In some cases, the water intrusion may be severe so as to fill the bottom rail and breach over the sill, thereby spilling over into the home interior. Existing solutions fail to offer practical, efficient, and homeowner-friendly methods for mitigating water intrusion. Hence, there exists a critical need for a lightweight, easy-to-install-and-remove interior water barrier system.

### SUMMARY OF THE INVENTION

Embodiments of the present disclosure provide a splash guard apparatus configured to form an interior water barrier along a sill and adjacent frame of a sliding door or window assembly.

In one aspect, an apparatus for mitigating water intrusion along a sill of a sliding door or window, comprises: a panel made of a semi-rigid material and including a vertically oriented portion and a bottom portion; at least one foldable region extending generally horizontally across the panel and configured to enable the bottom portion to be positioned at an angle relative to the vertically oriented portion; and a sealing interface disposed along at least a bottom edge and one or more side edges of the panel, wherein the sealing interface is configured to engage a sill surface and an adjacent frame surface such that the panel forms a barrier to water intrusion.

In another aspect, an apparatus includes a semi-rigid panel having a vertically oriented portion and a bottom portion, the panel including at least one foldable region extending generally horizontally and enabling the bottom portion to be positioned at an angle relative to the vertically oriented portion. A compliant sealing interface is disposed along at least a bottom edge and one or more side edges of the panel and is configured to engage surfaces of the sill and frame to form a water-resistant barrier.

In another aspect, a system includes a plurality of such panels arranged in series along a length of a sill, wherein adjacent panels overlap to form a continuous barrier. Such a system for mitigating water intrusion, comprises: a plurality of panels arranged along a length of a sill, each of the panels being an apparatus for mitigating water intrusion along a sill of a sliding door or window, and each panel comprising a panel comprising a semi-rigid material and including a vertically oriented portion and a bottom portion, at least one foldable region extending generally horizontally across the panel and configured to enable the bottom portion to be positioned at an angle relative to the vertically oriented portion, and a sealing interface disposed along at least a bottom edge and one or more side edges of the panel, wherein the sealing interface is configured to engage a sill surface and an adjacent frame surface such that the panel forms a barrier to water intrusion; wherein adjacent panels overlap to form a continuous barrier.

In yet another aspect, a method includes folding the panel along the foldable region, positioning the panel along the sill and frame, and pressing the panel into engagement such that the sealing interface conforms to the surfaces and establishes a barrier against water intrusion. The method of mitigating water intrusion, comprises: providing a panel being an apparatus for mitigating water intrusion along a sill of a sliding door or window, the panel comprising, a panel comprising a semi-rigid material and including a vertically oriented portion and a bottom portion, at least one foldable region extending generally horizontally across the panel and configured to enable the bottom portion to be positioned at an angle relative to the vertically oriented portion, and a sealing interface disposed along at least a bottom edge and one or more side edges of the panel, wherein the sealing interface is configured to engage a sill surface and an adjacent frame surface such that the panel forms a barrier to water intrusion; folding the panel along the foldable region; positioning the panel along a sill and adjacent frame; and pressing the panel such that a sealing interface engages the sill and frame to form a barrier.

The construction and method of operation and installation of the invention and additional objects and advantages of the invention are best understood from the following description of specific embodiments when read in connection with the accompanying drawings.

### BRIEF DESCRIPTION OF THE DRAWINGS

The accompanying drawings illustrate embodiments of the splash guard apparatus and are not limiting.

FIG. 1 is an isometric view of a typical installation of the apparatus in a sliding door system, according to an embodiment;

FIG. 2 is a front view of another typical installation according to another embodiment;

FIG. 3 is a top view of FIG. 2;

FIG. 4 is a front view of a system of panels according to an embodiment;

FIG. 5 is a top view of FIG. 4;

FIG. 6 is a back view of a panel according to an embodiment;

FIG. 7 is a top view of FIG. 6;

FIG. 8 is a side view of a panel in a flat state according to an embodiment;

FIG. 9 is a detailed view of FIG. 8;

FIG. 10 is a side view of the panel of FIG. 8 in a folded state according to an embodiment;

FIG. 11 is a detailed view of FIG. 10

FIG. 12 is a back isometric exploded view of FIG. 6 in a flat state;

FIG. 13 shows the panel of FIG. 12 in a folded state;

FIG. 14 is a back view of FIG. 13 in an unexploded state;

FIG. 15 is a top view of FIG. 14; and

FIG. 16 is an isometric view of FIG. 14.

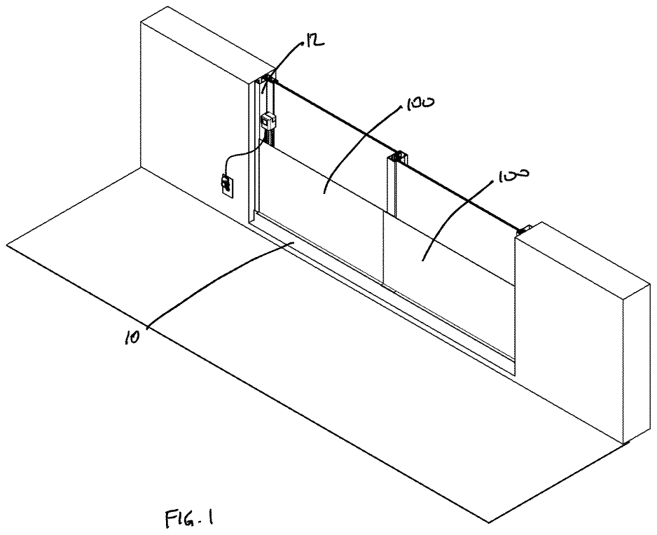

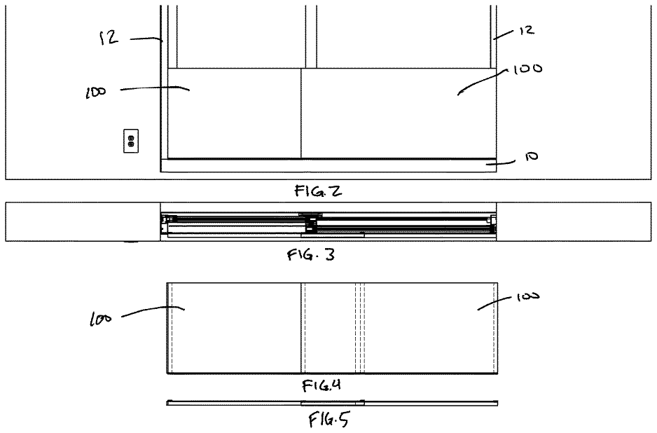

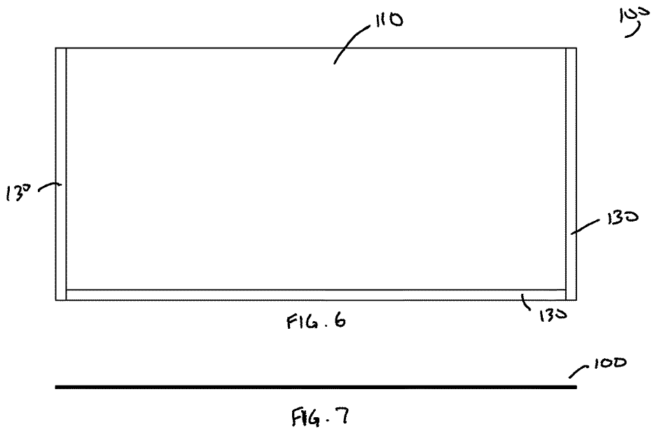

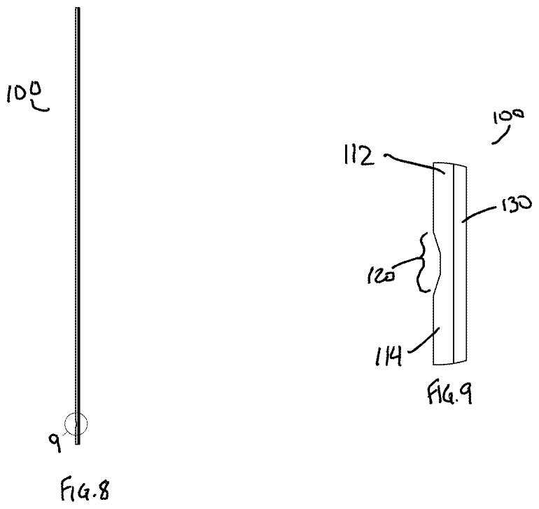

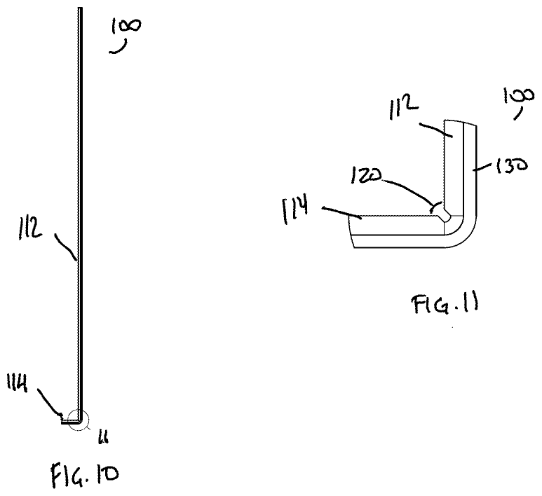

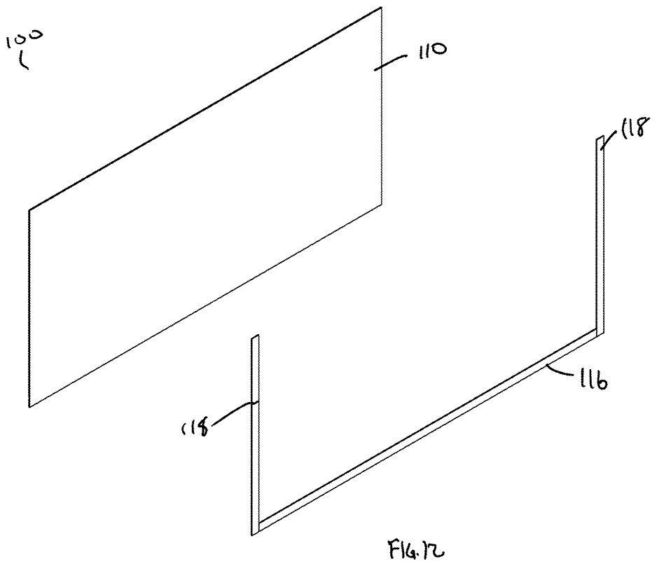

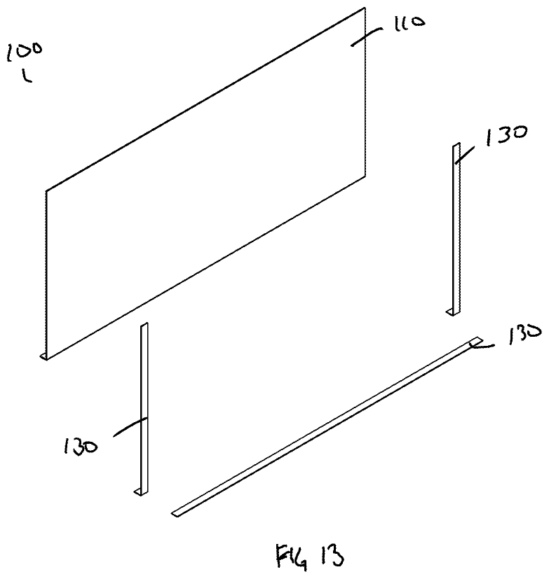

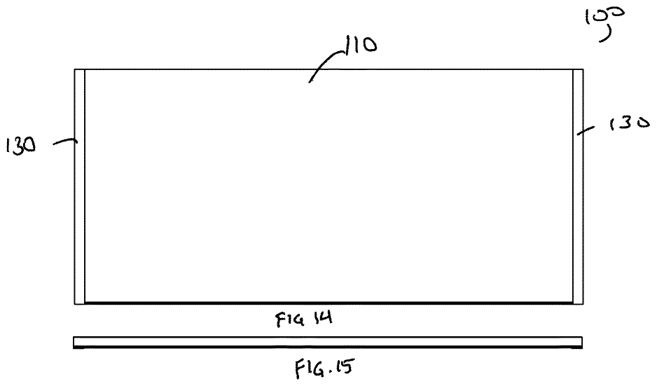

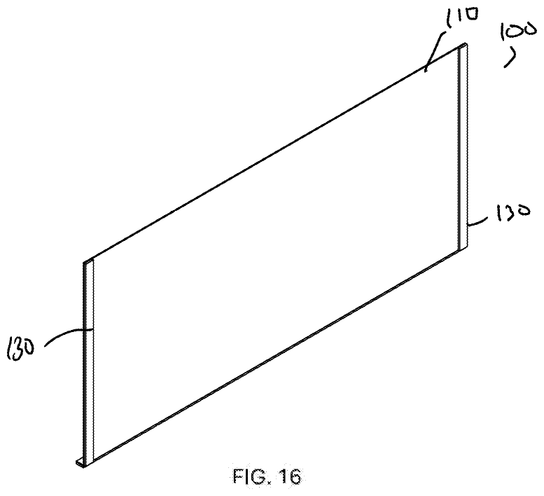

### DETAILED DESCRIPTION

The present invention provides a water barrier apparatus particularly suited for use with sliding glass doors in residential structures, effectively preventing water intrusion during extreme weather conditions involving wind-driven rain. The apparatus comprises a substantially rectangular semi-rigid panel constructed from waterproof or water-resistant material, providing sufficient rigidity to stand upright when installed. Compliant adhesive foam strips are strategically positioned along the panel's bottom and side edges on the rear surface to enable secure attachment to surfaces of varying textures or imperfections commonly found in residential sliding door assemblies.

An integral feature of the apparatus is a horizontally oriented living hinge created by thinning the panel material along a line parallel to its bottom edge and, preferably, on the side of the panel opposite the adhesive. This living hinge allows the lower portion of the panel to be folded outwardly approximately 90 degrees relative to the upper portion. This folded configuration facilitates direct adhesion of the bottom portion onto the sliding door sill's horizontal surface, while the upper vertical portion simultaneously contacts and adheres to the adjacent frame.

The method of installation begins by manually folding the panel forward along the hinge line. The installer then positions the apparatus on the sliding door sill, with the folded bottom portion resting horizontally on top of the sill. The vertical portion of the panel is pressed firmly against the vertical frame, activating the compliant adhesive foam strips. These strips compress slightly to accommodate and seal around surface irregularities such as screw heads or minor imperfections, thus ensuring a robust, water-tight seal.

In situations involving larger sliding door openings that exceed the width of a single panel, the invention includes a system of multiple panels. Each panel is installed sequentially, overlapping adjacent panels to form a continuous, water-tight barrier spanning the entire width of the sliding door opening. This system configuration ensures comprehensive protection from water intrusion, even in expansive sliding door installations.

An alternative embodiment of the apparatus introduces a second horizontal living hinge positioned between the primary hinge and the bottom edge of the panel. This secondary hinge enables an additional downward bend, permitting the panel to adhere securely to the vertical front face of the sill, thus further enhancing the barrier's sealing capacity and overall performance.

The present invention thereby offers an efficient, practical, and user-friendly solution to homeowners, significantly mitigating the risk of water intrusion from sliding glass door assemblies during severe weather events.

### Overall Configuration

Referring to the figures, a splash guard apparatus 100 is configured for placement along an interior side of a sliding door or window assembly. The apparatus 100 is positioned along a sill 10 and adjacent frame 12 to form a barrier that reduces or prevents water intrusion into an interior space.

The apparatus 100 generally includes a panel 110, a foldable region 120, and a sealing interface 130.

### Panel

The panel 110 comprises a semi-rigid, water-resistant or water-impermeable material. In embodiments, the panel is formed from a polymeric sheet material such as polypropylene, polyethylene, or other plastics, although other materials having sufficient rigidity to maintain an upright configuration may be used.

The panel 110 includes:
a vertically oriented portion 112 configured to extend upward from the sill; and
a bottom portion 114 configured to engage a horizontal surface of the sill.

The panel 110 is dimensioned to span at least a portion of the width of the sliding door or window opening.

### Foldable Region

The foldable region 120 extends generally horizontally across the panel 110 and separates the vertically oriented portion 112 from the bottom portion 114.

The foldable region 120 is formed by a localized reduction in thickness or other structural configuration that enables bending of the panel. This configuration allows the bottom portion 114 to be positioned at an angle relative to the vertically oriented portion 112, including approximately perpendicular orientations.

In some embodiments, the panel may include a second foldable region positioned between the first foldable region and the bottom edge, enabling additional conformity to the geometry of the sill and frame.

### Sealing Interface

A sealing interface 130 is disposed along at least a bottom edge 116 and one or more side edges 118 of the panel 110.

The sealing interface 130 comprises a compliant material configured to conform to irregularities in the sill and frame surfaces. In embodiments, the sealing interface includes an adhesive-backed foam material. The sealing interface may provide both sealing and attachment functions.

The sealing interface is positioned such that, upon installation, it contacts:
a horizontal surface of the sill; and
a vertical surface of the frame.

### Installation and Operation

During installation, the panel 110 is bent along the foldable region 120 such that the bottom portion 114 extends outward relative to the vertically oriented portion 112.

The panel 110 is positioned along the sill 10 with the bottom portion 114 contacting a horizontal surface and the vertically oriented portion 112 contacting the frame 12.

The panel is pressed into engagement such that the sealing interface 130 conforms to the surfaces, forming a water-resistant barrier. The compliant material accommodates surface irregularities and maintains sealing contact.

When water accumulates within the track or sill region, the panel 110 functions as a barrier that increases the effective height of the sill and prevents overflow into the interior.

### System Embodiments

Multiple panels 110 may be arranged along the width of a door or window opening. Adjacent panels may overlap at side edges to form a continuous barrier.

The overlapping configuration reduces gaps between panels and enhances sealing performance across wider openings.

### Alternative Embodiments

The panel may be formed in various shapes and sizes depending on the application. The foldable region may be implemented using different techniques, including material thinning, scoring, or incorporation of flexible materials.

The sealing interface may include different compliant materials or attachment mechanisms, including pressure-sensitive adhesives or other removable attachment configurations.

### Advantages

The disclosed splash guard provides:
rapid installation without tools;
removability without permanent modification;
conformity to irregular surfaces; and
improved resistance to water intrusion under elevated water conditions.

The description of the present disclosure has been presented for purposes of illustration and description, but is not intended to be exhaustive or limited to the invention in the form disclosed. Many modifications and variations will be apparent to those of ordinary skill in the art without departing from the scope and spirit of the disclosure. In particular, features from one embodiment can be used with another embodiment. The embodiments were chosen and described to best explain the principles of the disclosure and the practical application, and to enable others of ordinary skill in the art to understand the invention for various embodiments with various modifications as are suited to the particular use contemplated.

Drawing figures are concurrently filed herewith and form part of the present disclosure.

1. An apparatus for mitigating water intrusion along a sill of a sliding door or window, comprising:
a panel comprising a semi-rigid material and including a vertically oriented portion and a bottom portion;
at least one foldable region extending generally horizontally across the panel and configured to enable the bottom portion to be positioned at an angle relative to the vertically oriented portion; and
a sealing interface disposed along at least a bottom edge and one or more side edges of the panel,
wherein the sealing interface is configured to engage a sill surface and an adjacent frame surface such that the panel forms a barrier to water intrusion.

2. The apparatus of claim 1, wherein the foldable region comprises a region of reduced thickness.

3. The apparatus of claim 1, wherein the sealing interface comprises an adhesive-backed foam material.

4. The apparatus of claim 1, wherein the panel comprises a polymeric sheet.

5. The apparatus of claim 1, wherein the panel is formed from polypropylene.

6. The apparatus of claim 1, further comprising a second foldable region.

7. The apparatus of claim 1, wherein the sealing interface is configured to conform to surface irregularities.

8. The apparatus of claim 1, wherein the panel is removable from the sill without tools.

9. The apparatus of claim 1, wherein the panel is configured to increase an effective height of the sill.

10. The apparatus of claim 1, wherein the sealing interface is disposed along the bottom edge and both side edges.

11. The apparatus of claim 1, wherein the bottom portion is configured to lie along a horizontal surface of the sill.

12. The apparatus of claim 1, wherein the vertically oriented portion is configured to engage a vertical frame surface.

13. A system for mitigating water intrusion, comprising:
a plurality of panels arranged along a length of a sill, each of the panels being an apparatus for mitigating water intrusion along a sill of a sliding door or window, comprising:
a panel comprising a semi-rigid material and including a vertically oriented portion and a bottom portion;
at least one foldable region extending generally horizontally across the panel and configured to enable the bottom portion to be positioned at an angle relative to the vertically oriented portion; and
a sealing interface disposed along at least a bottom edge and one or more side edges of the panel,
wherein the sealing interface is configured to engage a sill surface and an adjacent frame surface such that the panel forms a barrier to water intrusion,
wherein adjacent panels overlap to form a continuous barrier.

14. The system of claim 13, wherein the panels overlap along side edges.

15. A method of mitigating water intrusion, comprising:
providing a panel being an apparatus for mitigating water intrusion along a sill of a sliding door or window, comprising:
a panel comprising a semi-rigid material and including a vertically oriented portion and a bottom portion;
at least one foldable region extending generally horizontally across the panel and configured to enable the bottom portion to be positioned at an angle relative to the vertically oriented portion; and
a sealing interface disposed along at least a bottom edge and one or more side edges of the panel,
wherein the sealing interface is configured to engage a sill surface and an adjacent frame surface such that the panel forms a barrier to water intrusion;
folding the panel along the foldable region;
positioning the panel along a sill and adjacent frame; and
pressing the panel such that a sealing interface engages the sill and frame to form a barrier.

16. The method of claim 15, wherein the sealing interface comprises an adhesive foam.

17. The method of claim 15, further comprising overlapping a plurality of panels.
